(19) United States
(12) Patent Application Publication
(10) Pub. No.: US 2026/0280697 A1
(43) Pub. Date: Sep. 17, 2026

(54) SEABED OPTICAL COMMUNICATION SYSTEM, METHOD FOR CONTROLLING SAME, AND NON-TRANSITORY COMPUTER-READABLE MEDIUM HAVING CONTROL PROGRAM STORED THEREIN

(71) Applicant: NEC Corporation, Tokyo (JP)

(72) Inventor: Hideo ASADA, Tokyo (JP)

(73) Assignee: NEC Corporation, Tokyo (JP)

(21) Appl. No.: 19/166,898

(22) PCT Filed: Mar. 28, 2023
(86) PCT No.: PCT/JP2023/012547

§ 371 Date: Sep. 19, 2025

(51) Int. Cl. H04B 10/077; H04B 10/25; H04B 10/29

(52) U.S. Cl. CPC H04B 10/0771; H04B 10/25; H04B 10/29

(57) ABSTRACT

A seabed optical communication system comprises: a first multi-core fiber through which an optical signal used for communication between a plurality of terminal station devices is transmitted; and a first seabed instrument and a second seabed instrument that are configured to switch connections of a plurality of first cores constituting the first multi-core fiber. At least one of the plurality of terminal station devices includes: a monitoring circuit; and a control circuit that, upon determining that there is a malfunction in one of a plurality of first partial cores constituting a first partial multi-core fiber provided between the first seabed instrument and the second seabed instrument in the first multi-core fiber, switches the transmission path of the optical signal that had been transmitted by the first partial core determined as having a malfunction, to another first partial core through which an optical signal having low priority is transmitted.

### TECHNICAL FIELD

The present disclosure relates to a seabed optical communication system, a control method thereof, and a non-transitory computer-readable medium storing a control program.

### BACKGROUND ART

A seabed optical communication system includes a plurality of terminal devices provided on land, a seabed cable that transmits communication between the terminal devices, and a seabed device provided at a relay point of the seabed cable. The seabed device transmits, relays, and splits optical signals propagating through the seabed cable.

In recent years, an increase in transmission capacity is required for a seabed optical communication system. In order to satisfy such a requirement, it has been studied to use a seabed cable made of a multicore fiber including a plurality of cores for a seabed optical communication system.

Techniques related to the seabed optical communication system are disclosed in, for example, PTL 1, PTL 2, PTL 3, and PTL 4. In these related technologies, in a case where a multicore fiber of a cable fails, a transmission path of a signal transmitted by the failed multicore fiber is switched to a spare multicore fiber.

### CITATION LIST

### Patent Literature

PTL 1: JP 2014-165595 A

PTL 2: JP 2015-109515 A

PTL 3: JP 2016-111480 A

### SUMMARY OF INVENTION

### Technical Problem

However, in the related art, since it is necessary to provide a spare multicore fiber and a spare core in the cable, there is a problem that the cost increases.

The present disclosure has been made to solve such a problem, and an object of the present disclosure is to provide a seabed optical communication system capable of suppressing an increase in cost by optimizing communication without using a spare multicore fiber or a spare core even in a case where a failure occurs in a multicore fiber of a cable, a control method thereof, and a non-transitory computer-readable medium storing a control program.

### Solution to Problem

A seabed optical communication system according to the present disclosure includes a plurality of terminal devices, a first multicore fiber including a plurality of first cores, which transmits an optical signal used for communication between the plurality of terminal devices, and a first seabed device and a second seabed device provided at relay points of the first multicore fiber and configured to be able to switch connection of a plurality of first cores configuring the first multicore fiber, in which wherein at least one of the plurality of terminal devices includes a monitoring circuit that monitors a signal transmission status of the first multicore fiber, and a control circuit that switches a transmission path of an optical signal transmitted by a first partial core determined to be faulty to another first partial core that transmits an optical signal having a lower priority than that of the first partial core determined to be faulty in a case where the monitoring circuit determines that any of a plurality of first partial cores configuring a first partial multicore fiber provided between the first seabed device and the second seabed device among the first multicore fibers is faulty.

A method of controlling a seabed optical communication system according to the present disclosure, the system including a plurality of terminal devices, a first multicore fiber including a plurality of first cores, which transmits an optical signal used for communication between the plurality of terminal devices, and a first seabed device and a second seabed device provided at relay points of the first multicore fiber and configured to be able to switch connection of a plurality of first cores configuring the first multicore fiber, includes monitoring a signal transmission status of the first multicore fiber using at least one of the plurality of terminal devices, and switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.

A non-transitory computer-readable medium storing a control program according to the present disclosure for causing a computer to execute control processing in a seabed optical communication system including a plurality of terminal devices, a first multicore fiber including a plurality of first cores, which transmits an optical signal used for communication between the plurality of terminal devices, and a first seabed device and a second seabed device provided at relay points of the first multicore fiber and configured to be able to switch connection of a plurality of first cores configuring the first multicore fiber, causes the computer to execute processing of monitoring a signal transmission status of the first multicore fiber using at least one of the plurality of terminal devices, and switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.

### Advantageous Effects of Invention

According to the present disclosure, it is possible to provide a seabed optical communication system capable of suppressing an increase in cost by optimizing communication without using a spare multicore fiber or a spare core even in a case where a failure occurs in a multicore fiber of a cable, a control method thereof, and a non-transitory computer-readable medium storing a control program.

### BRIEF DESCRIPTION OF DRAWINGS

FIG. 1 is a block diagram illustrating a configuration example of a seabed optical communication system according to a first example embodiment.

FIG. 2 is a diagram illustrating an operation of the seabed optical communication system illustrated in FIG. 1.

FIG. 3 is a block diagram illustrating a configuration example of a seabed optical communication system according to a second example embodiment.

FIG. 4 is a diagram illustrating an operation of the seabed optical communication system illustrated in FIG. 3.

FIG. 5 is a block diagram illustrating a configuration example of a seabed optical communication system according to a third example embodiment.

FIG. 6 is a diagram illustrating an operation of the seabed optical communication system illustrated in FIG. 5.

FIG. 7 is a diagram illustrating an operation of the seabed optical communication system illustrated in FIG. 5.

FIG. 8 is a diagram illustrating an operation of the seabed optical communication system illustrated in FIG. 5.

FIG. 9 is a diagram illustrating an operation of the seabed optical communication system illustrated in FIG. 5.

FIG. 10 is a diagram illustrating an operation of the seabed optical communication system illustrated in FIG. 5.

FIG. 11 is a block diagram illustrating a modified example of the terminal device.

### EXAMPLE EMBODIMENT

Hereinafter, example embodiments will be described with reference to the drawings. Since the drawings are simplified, the technical scope of the example embodiments should not be narrowly interpreted based on the description of the drawings. The same elements are denoted by the same reference numerals, and redundant description will be omitted.

In the following example embodiments, if necessary for convenience, the description will be divided into a plurality of sections or example embodiments.

However, unless otherwise specified, they are not unrelated to each other, and one is in a relationship of some or all modified examples, application examples, detailed descriptions, supplementary descriptions, and the like of the other. In the following example embodiments, in case referring to the number of elements and the like (including number, numerical value, amount, range, and the like), the number is not limited to a specific number unless otherwise specified or clearly limited to the specific number in principle, and the number may be equal to or more than the specific number or may be equal to or less than the specific number.

Furthermore, in the following example embodiments, the components (including operation steps and the like) are not necessarily essential unless otherwise specified or considered to be obviously essential in principle.

Similarly, in the following example embodiments, in case referring to the shape, positional relationship, etc. of components, etc., it is intended to include things £ that are substantially similar or approximate to those shapes, etc., unless otherwise specified or considered to be clearly different in principle. The same applies to the above numbers (including number, numerical value, amount, range, and the like).

### First Example Embodiment

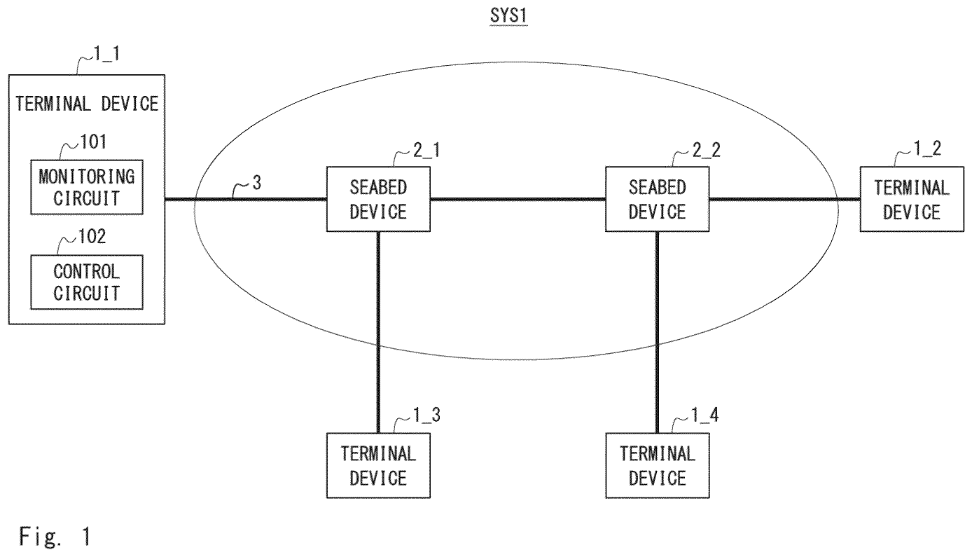

FIG. 1 is a block diagram illustrating a configuration example of a seabed optical communication system SYS1 according to a first example embodiment.

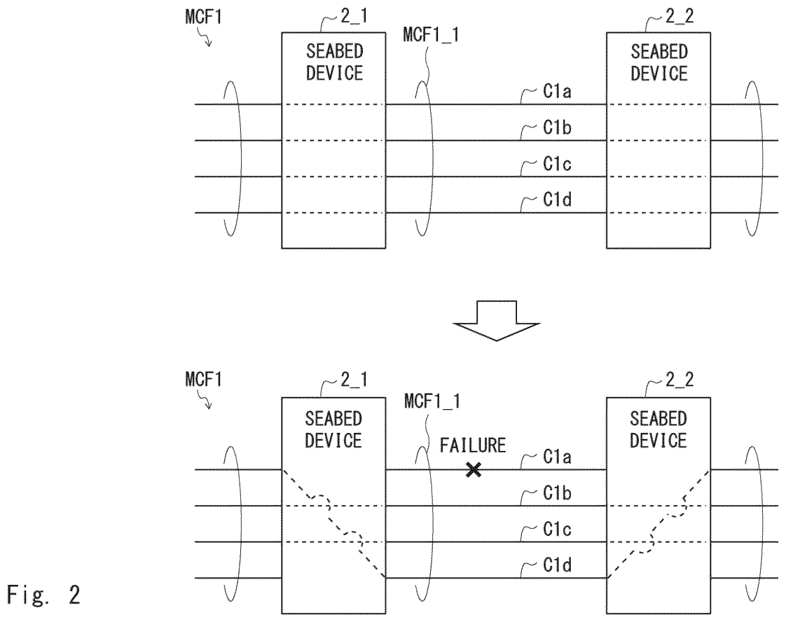

FIG. 2 is a diagram illustrating an operation of the seabed optical communication system SYS1.

As illustrated in FIG. 1, a seabed optical communication system SYS1 includes a plurality of terminal devices 1, a plurality of seabed devices 2, and a seabed cable 3. In the present example embodiment, a case where the seabed optical communication system SYS1 includes four terminal devices 1_1 to 1_4 as a plurality of terminal devices 1 and two seabed devices 2_1 to 2_2 as a plurality of seabed devices 2 will be described as an example.

The terminal devices 1_1 to 1_4 are provided on land and are configured to be able to communicate with each other via the seabed cable 3. Each of the terminal devices 1_1 to 1_4 includes, for example, wavelength multiplexing equipment (WME), open cable interface (OCI), subscriber line terminal equipment (SLTE), transponder (TPND), and the like. At least one of the terminal devices 1_1 to 1_4 includes a monitoring circuit 101 and a control circuit 102. In the present example embodiment, a case where the terminal device 1_1 includes a monitoring circuit 101 and a control circuit 102 will be described as an example.

The seabed cable 3 is an optical fiber cable that transmits an optical signal used for communication between the terminal devices 1_1 to 1_4. Specifically, the seabed cable 3 includes a multicore fiber including a plurality of cores. In the present example embodiment, as illustrated in FIG. 2, a case where the seabed cable 3 includes a multicore fiber MCF1 including four cores will be described as an example.

Each of the seabed devices 2_1 to 2_2 is provided at a relay point (seabed) of the seabed cable 3, and transmits, relays, and splits an optical signal propagating through the seabed cable 3. The seabed devices 2_1 to 2_2 are configured to be able to switch a connection of four cores configuring the multicore fiber MCF1 included in the seabed cable 3.

Here, in the terminal device 1_1, the monitoring circuit 101 monitors a signal transmission status of the seabed cable 3. In other words, the monitoring circuit 101 monitors the signal transmission status of the multicore fiber MCF1 included in the seabed cable 3.

The control circuit 102 causes the seabed devices 2_1 to 2_2 to switch the connection of the four cores configuring the multicore fiber MCF1 based on the monitoring result by the monitoring circuit 101. Priority of an optical signal to be transmitted is set for each core. The cores that transmit the optical signal with low priority also includes a core in which transmission of the optical signal is temporarily stopped.

Specifically, in a case where the monitoring circuit 101 determines that any of cores (first partial cores) C1a to C1d configuring a multicore fiber (first partial multicore fiber) MCF1_1 provided between the seabed device 2_1 and the seabed device 2_2 in the multicore fiber MCF1 is faulty, the control circuit 102 switches the transmission path of the optical signal transmitted by the core determined to be faulty to another core that transmits an optical signal having a lower priority than the core determined to be faulty.

For example, in a case where the monitoring circuit 101 determines that the core C1a, which is one of the cores C1a to C1d configuring the multicore fiber MCF1_1 provided between the seabed device 2_1 and the seabed device 2_2, of the multicore fiber MCF1 is faulty, the control circuit 102 switches the transmission path of the optical signal transmitted by the core C1a to the core C1d that transmits the optical signal having a lower priority than that of the core C1a.

As described above, in the seabed optical communication system SYS1 according to the present example embodiment, even in a case where a failure occurs in the seabed cable 3, communication can be optimized without using the spare multicore fiber or the spare core, in such a way that the cost required for the spare multicore fiber or the spare core can be suppressed.

For example, the seabed optical communication system SYS1 according to the present example embodiment only needs to switch the connection of only the core portion between the two seabed devices in which the failure has occurred among the cores of the seabed cable 3 provided from the terminal device 1_1 to the terminal device 1_2 to another core. Therefore, instantaneous interruption or the like of the core in which no failure occurs can be prevented.

In the present example embodiment, the case where the control circuit 102 switches the connection of the plurality of cores configuring the multicore fiber provided between the seabed device 2_1 and the seabed device 2_2 in the multicore fiber MCF1 has been described as an example, but the present disclosure is not limited thereto. For example, the control circuit 102 may be configured to switch connection of a plurality of cores configuring a multicore fiber provided between the terminal device 1_1 and the seabed device 2_1 in the multicore fiber MCF1.

In the present example embodiment, the case where the seabed optical communication system SYS1 includes the two seabed devices 2_1 and 2_2 has been described as an example, but the present disclosure is not limited thereto.

The seabed optical communication system SYS1 can be appropriately changed to a configuration including three or more seabed devices 2_1 to 2_n (n is an integer of 3 or more).

### Second Example Embodiment

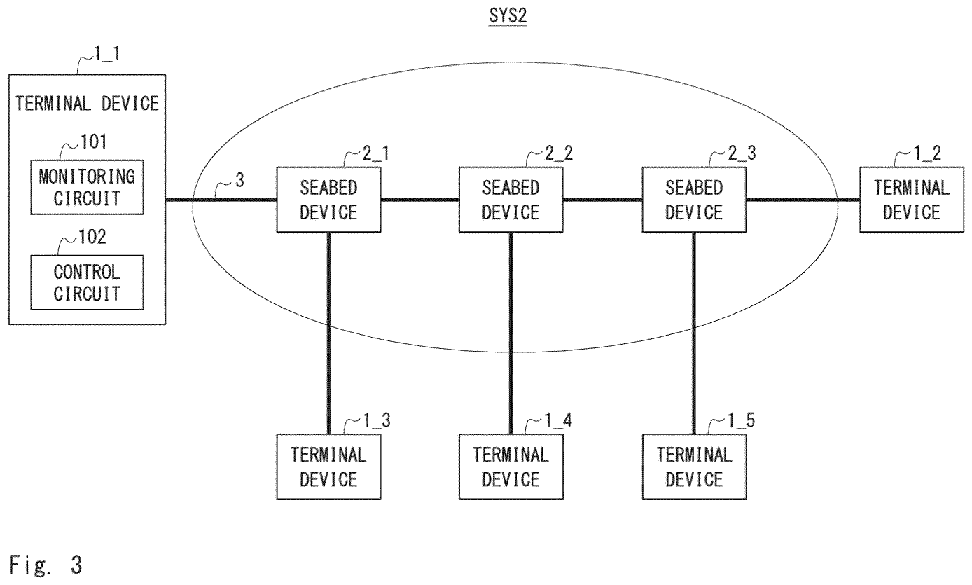

FIG. 3 is a block diagram illustrating a configuration example of a seabed optical communication system SYS2 according to a second example embodiment.

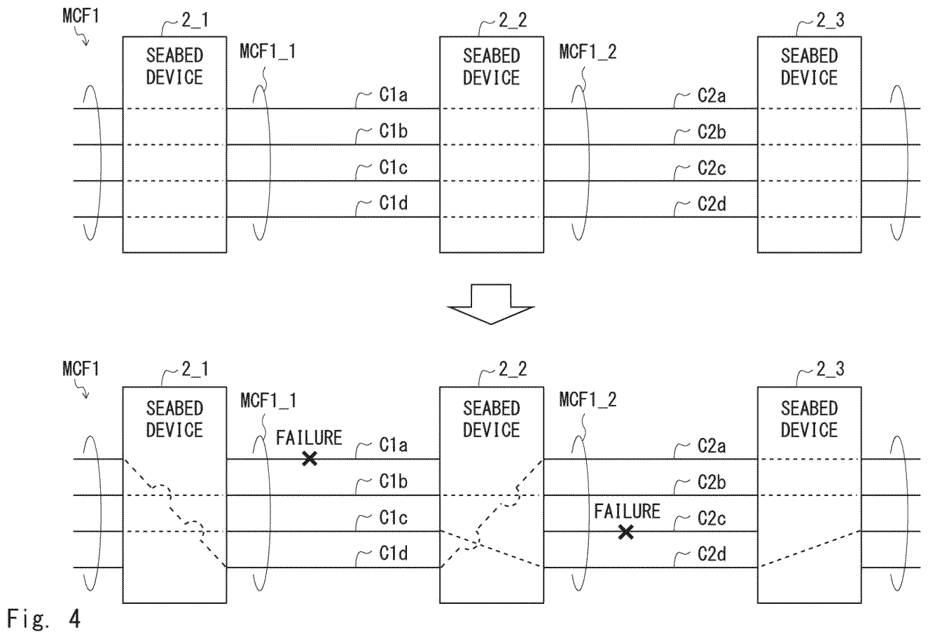

FIG. 4 is a diagram illustrating an operation of the seabed optical communication system SYS2. As illustrated in FIG. 3, the seabed optical communication system SYS2 includes five terminal devices 1_1 to 1_5 as the plurality of terminal devices 1, and three seabed devices 2_1 to 2_3 as the plurality of seabed devices 2. Since other configurations of the seabed optical communication system SYS2 are similar to those of the seabed optical communication system SYS1, the description thereof will be omitted.

Similarly to the seabed devices 2_1 to 2_2, the seabed device 2_3 is provided at a relay point (seabed) of the seabed cable 3, and transmits, relays, and splits an optical signal propagating through the seabed cable 3. The seabed devices 2_1 to 2_3 are configured to be able to switch the connection of four cores configuring the multicore fiber MCF1 included in the seabed cable 3.

The control circuit 102 causes the seabed devices 2_1 to 2_3 to switch the connection of the four cores configuring the multicore fiber MCF1 based on the monitoring result by the monitoring circuit 101.

More specifically, the control circuit 102 causes the seabed devices 2_1 to 2_3 to individually switch between the connection of four cores C1a to C1d configuring a multicore fiber MCF1_1 provided between the seabed device 2_1 and the seabed device 2_2 and the connection of four cores (second partial cores) C2a to C2d configuring a multicore fiber (second partial multicore fiber) MCF1_2 provided between the seabed device 2_2 and the seabed device 2_3 based on the monitoring result by the monitoring circuit 101.

For example, in a case where the monitoring circuit 101 determines that the core C1a, which is one of the cores C1a to C1d configuring the multicore fiber MCF1_1 provided between the seabed device 2_1 and the seabed device 2_2, of the multicore fiber MCF1 is faulty, the control circuit 102 switches the transmission path of the optical signal transmitted by the core C1a to the core C1d that transmits the optical signal having a lower priority than that of the core C1a.

Further, in a case where the monitoring circuit 101 determines that the core C2c, which is one of the cores C2a to C2d configuring the multicore fiber MCF1_2 provided between the seabed device 2_2 and the seabed device 2_3, of the multicore fiber MCF1 is faulty, the control circuit 102 switches the transmission path of the optical signal transmitted by the core C2c to the core C2d that transmits the optical signal having a lower priority than that of the core C2c.

As described above, in the seabed optical communication system SYS2 according to the present example embodiment, even in a case where a failure occurs in the seabed cable 3, communication can be optimized without using the spare multicore fiber or the spare core, in such a way that the cost required for the spare multicore fiber or the spare core can be suppressed.

For example, the seabed optical communication system SYS2 according to the present example embodiment only needs to switch the connection of only the core portion between the two seabed devices in which the failure has occurred among the cores of the seabed cable 3 provided from the terminal device 1_1 to the terminal device 1_2 to another core. Therefore, instantaneous interruption or the like of the core and the multicore fiber in which no failure occurs can be prevented.

In the present example embodiment, the case where the control circuit 102 switches the connection of the plurality of cores configuring the multicore fiber provided between the seabed device 2_1 and the seabed device 2_2 in the multicore fiber MCF1 has been described as an example, but the present disclosure is not limited thereto. For example, the control circuit 102 may be configured to switch connection of a plurality of cores configuring a multicore fiber provided between the terminal device 1_1 and the seabed device 2_1 in the multicore fiber MCF1.

### Third Example Embodiment

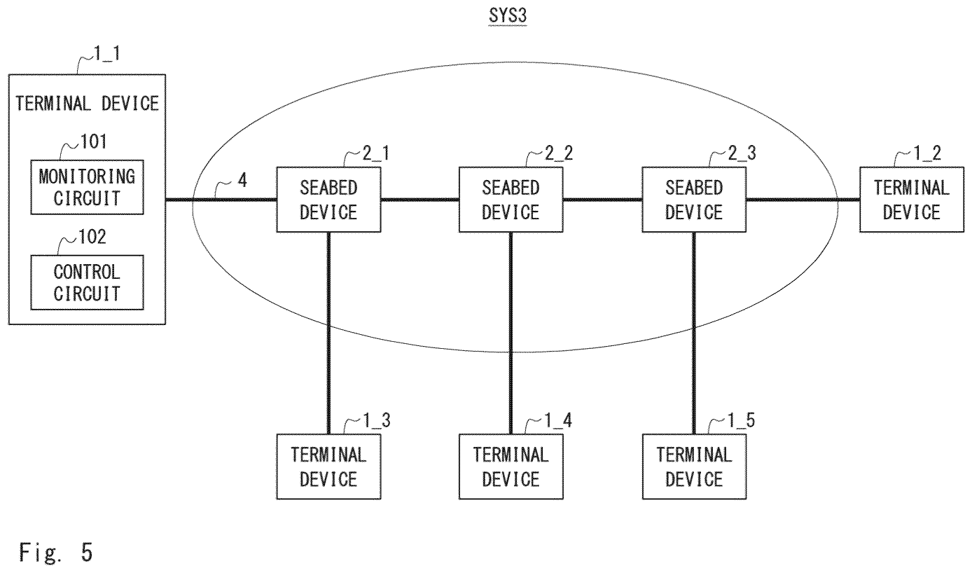

FIG. 5 is a block diagram illustrating a configuration example of a seabed optical communication system SYS3 according to a third example embodiment.

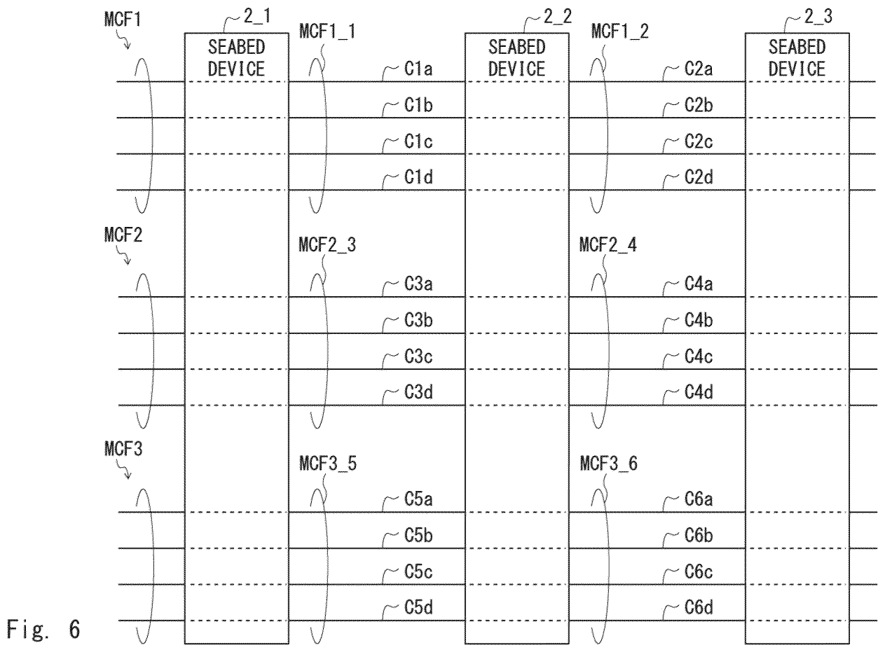

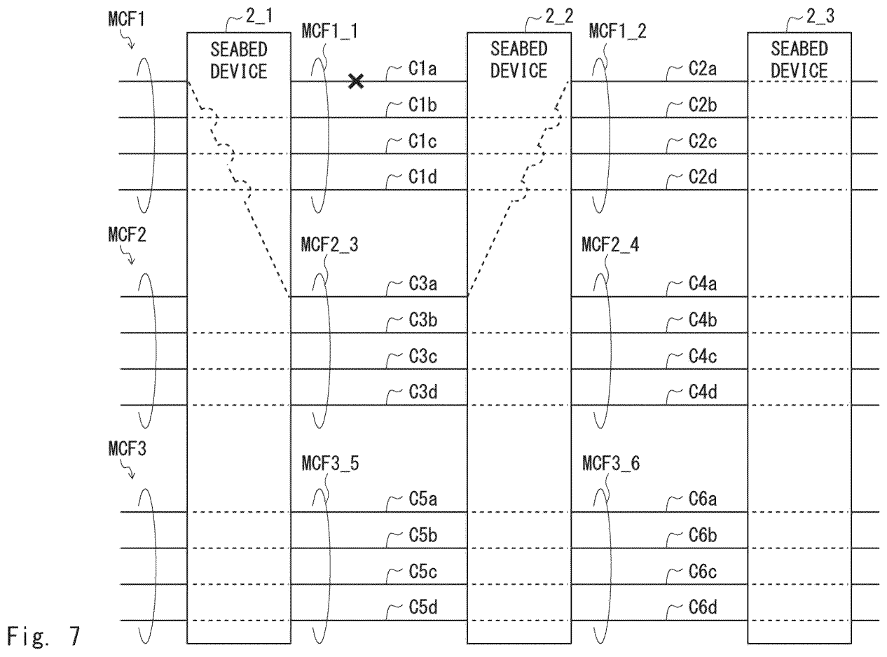

FIGS. 6 to 10 are diagrams illustrating the operation of the seabed optical communication system SYS3. FIG. 6 illustrates a part of the seabed optical communication system SYS3 before the seabed cable fails, and FIGS. 7 to 10 illustrate a part of the seabed optical communication system SYS3 in a state where the seabed cable has failed.

As illustrated in FIG. 5, the seabed optical communication system SYS3 includes a seabed cable 4 instead of the seabed cable 3 as compared with the seabed optical communication system SYS2. Since other configurations of the seabed optical communication system SYS3 are similar to those of the seabed optical communication system SYS2, the description thereof will be omitted.

The seabed cable 4 includes a plurality of multicore fibers. In the present example embodiment, as illustrated in FIG. 6, a case where the seabed cable 4 includes three multicore fibers MCF1 to MCF3 will be described as an example. Each of the multicore fibers MCF1 to MCF3 includes four cores. However, each of the multicore fibers MCF1 to MCF3 may include any number of cores.

The seabed devices 2_1 to 2_3 are configured to be able to switch connection of four cores configuring the multicore fibers MCF1 to MCF3. The seabed devices 2_1 to 2_3 are configured to be able to switch the connection between the multicore fibers MCF1 to MCF3.

The control circuit 102 causes the seabed devices 2_1 to 2_3 to switch the connection of the four cores configuring the multicore fibers MCF1 to MCF3 based on the monitoring result by the monitoring circuit 101. Alternatively, the control circuit 102 causes the seabed devices 2_1 to 2_3 to switch the connection between the multicore fibers MCF1 to MCF3 based on the monitoring result by the monitoring circuit 101.

### First Example of Switching of Signal Transmission Path

In the example of FIG. 7, the monitoring circuit 101 determines that the core C11, which is one of the cores C1a to C1d configuring the multicore fiber MCF1_1 provided between the seabed device 2_1 and the seabed device 2_2 among the multicore fibers MCF1, is faulty. In this case, the control circuit 102 switches the transmission path of the optical signal transmitted by the core C1a to the core C3a that transmits the optical signal having a lower priority than the core C1a. The core C3a is one of the cores C3a to C3d configuring the multicore fiber MCF2_3 provided between the seabed device 2_1 and the seabed device 2_2 in the multicore fiber MCF2.

In this manner, connection switching in units of cores may be performed between a certain multicore fiber and another multicore fiber.

### Second Example of Switching of Signal Transmission Path

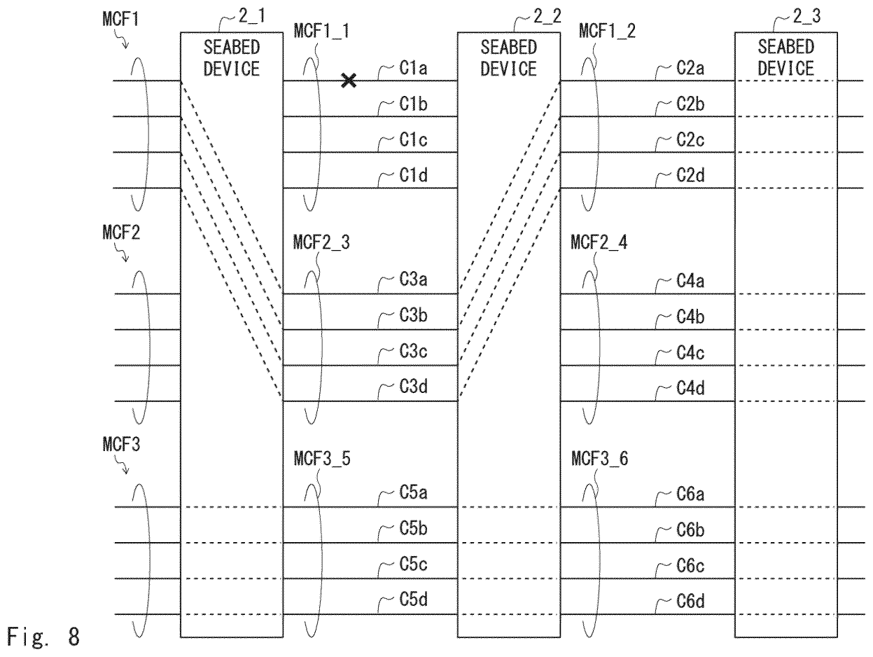

In the example of FIG. 8, the monitoring circuit 101 determines that the core C1a, which is one of the cores C1a to C1d configuring the multicore fiber MCF1_1 provided between the seabed device 2_1 and the seabed device 2_2 in the multicore fiber MCF1, is faulty. In this case, the control circuit 102 switches the transmission path of the optical signal transmitted by the multicore fiber MCF1_1 to the multicore fiber MCF2_3 that transmits the optical signal having a lower priority than the multicore fiber MCF1_1.

As described above, switching of the connection in units of multicore fibers may be performed between a certain multicore fiber and another multicore fiber.

### Third Example of Switching of Signal Transmission Path

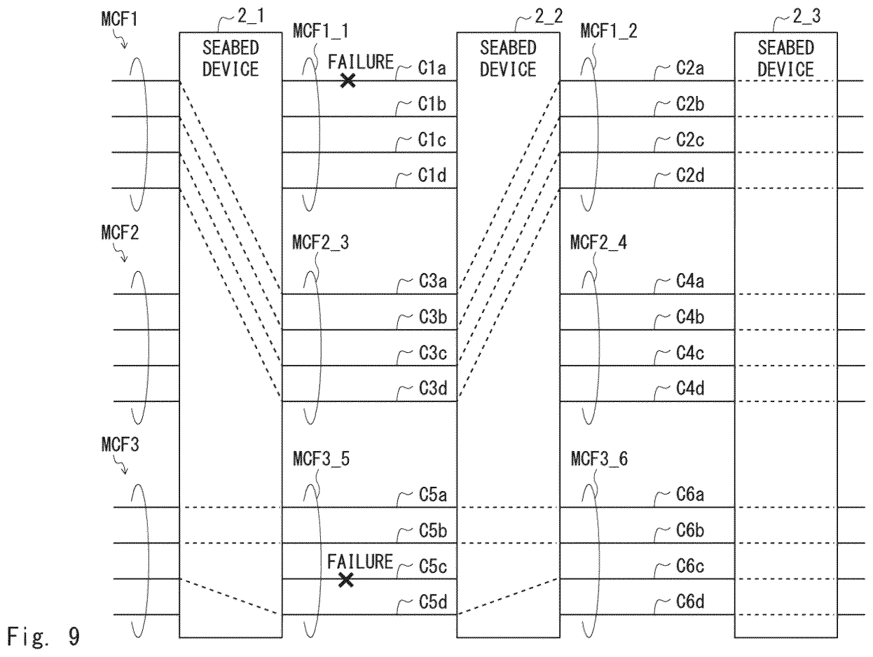

First, in the example of FIG. 9, the monitoring circuit 101 determines that the core C1a, which is one of the cores C1a to C1d configuring the multicore fiber MCF1_1 provided between the seabed device 2_1 and the seabed device 2_2 among the multicore fiber MCF1, is faulty. In this case, the control circuit 102 switches the transmission path of the optical signal transmitted by the multicore fiber MCF1_1 to the multicore fiber MCF2_3 that transmits the optical signal having a lower priority than the multicore fiber MCF1_1.

Further, in the example of FIG. 9, the monitoring circuit 101 determines that the core C5c, which is one of the cores C5a to C5d configuring the multicore fiber MCF3 5 provided between the seabed device 2_1 and the seabed device 2_2 among the multicore fibers MCF3, is faulty. In this case, the control circuit 102 switches the transmission path of the optical signal transmitted by the core C5c to the core C5d that transmits the optical signal having a lower priority than that of the core C5c.

As described above, the plurality of signal transmission paths may be switched for each of the plurality of failures.

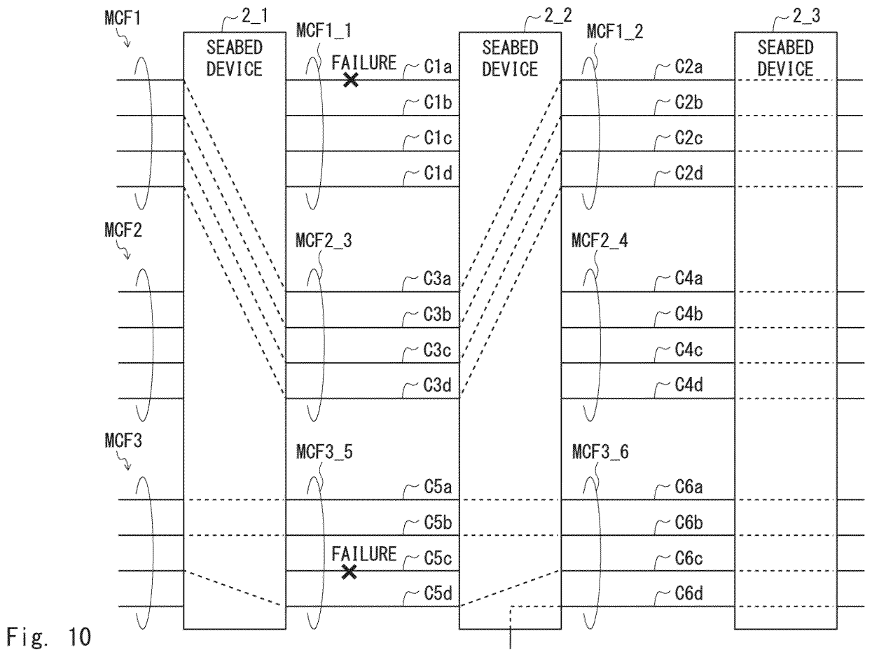

A core or a multicore fiber that is no longer used due to switching of the signal transmission path may be used for transmission of an optical signal supplied from a branch path. In the example of FIG. 10, the core C6d, which is one of the cores C6a to C6d configuring the multicore fiber MCF3_6 provided between the seabed device 2_2 and the seabed device 2_3 in the multicore fiber MCF3, is used for transmission of an optical signal supplied from the branch path.

As described above, even in a case where a failure occurs in the seabed cable 4, the seabed optical communication system SYS3 according to the present example embodiment can optimize communication without using the spare multicore fiber or the spare core, and thus, it is possible to suppress the cost required for the spare multicore fiber or the spare core.

For example, the seabed optical communication system SYS3 according to the present example embodiment only needs to switch the connection of only the core portion between the two seabed devices in which the failure has occurred among the cores of the seabed cable 4 provided from the terminal device 1_1 to the terminal device 1_2 to another core. Alternatively, for example, the seabed optical communication system SYS3 according to the present example embodiment only needs to switch the connection of only the multicore fiber portion between the two faulty seabed devices among the multicore fibers of the seabed cable 4 provided from the terminal device 1_1 to the terminal device 1_2 to another multicore fiber. Therefore, instantaneous interruption or the like of the core and the multicore fiber in which no failure occurs can be prevented.

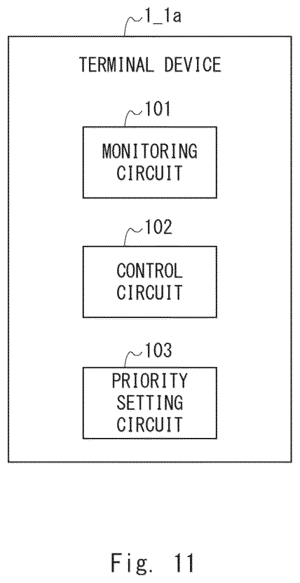

In addition to the monitoring circuit 101 and the control circuit 102, the terminal device 1_1 may have a function of setting a priority to each multicore fiber or setting a priority to each of a plurality of cores configuring each multicore fiber. A specific description will be given below with reference to FIG. 11.

FIG. 11 is a diagram illustrating a modified example of the terminal device 1 _as a terminal device 1_1a. The terminal device 1_1a further includes a priority setting circuit 103 as compared with the terminal device 1 1.

The priority setting circuit 103 sets priority to each multicore fiber included in the seabed cable 4 or sets priority to each of a plurality of cores configuring each multicore fiber.

Here, the priority setting circuit 103 can individually set priority to each multicore fiber provided between any two adjacent seabed devices and each of a plurality of cores configuring each multicore fiber. Similarly, the priority setting circuit 103 can individually set a priority for each multicore fiber provided between any adjacent terminal device and a seabed device and each of a plurality of cores configuring each multicore fiber.

The priority setting circuit 103 may be configured to set different priorities depending on time slots such as morning, daytime, and night for each multicore fiber provided between any two adjacent seabed devices and each of a plurality of cores configuring each multicore fiber. Similarly, the priority setting circuit 103 may be configured to set different priorities depending on a time slot for each multicore fiber provided between any adjacent terminal device and a seabed device and each of a plurality of cores configuring each multicore fiber.

The priority setting circuit 103 may be configured to set a common priority to cores belonging to the first group and set a common priority to cores belonging to the second group among a plurality of cores configuring each multicore fiber provided between any two adjacent seabed devices. Similarly, the priority setting circuit 103 may set a common priority to the cores belonging to the first group and set a common priority to the cores belonging to the second group among the plurality of cores configuring the multicore fiber provided between any adjacent terminal device and seabed device. The first group and the second group are, for example, different companies.

The priority setting circuit 103 may be configured to set the highest priority to at least one of the cores belonging to the first group and at least one of the cores belonging to the second group among the plurality of cores configuring the multicore fibers provided between any two adjacent seabed devices.

Similarly, the priority setting circuit 103 may be configured to set the highest priority to at least one of the cores belonging to the first group and at least one of the cores belonging to the second group among the plurality of cores configuring the multicore fiber provided between any adjacent terminal device and seabed device. This makes it possible to leave at least one core belonging to each group.

The priority setting circuit 103 may be configured to set the priority to each of the cores belonging to the first group and the cores belonging to the second group among the plurality of cores configuring each multicore fiber provided between any two adjacent seabed devices such that the ratio of the numbers of the cores is maintained. Similarly, the priority setting circuit 103 may be configured to set the priority to each of the cores belonging to the first group and the cores belonging to the second group among the plurality of cores configuring the multicore fibers provided between any adjacent terminal device and the seabed device such that the ratio of the numbers of the cores is maintained.

For example, in a case where the number of cores belonging to the first group is six and the number of cores belonging to the second group is three, in a case where three cores fail, the ratio of the cores belonging to the first group and the cores belonging to the second group is maintained, and the number of cores belonging to the first group is four and the number of cores belonging to the second group is two.

Although the example embodiments of the present disclosure have been described above in detail with reference to the drawings, specific configurations are not limited to the above, and various design changes and the like can be made without departing from the gist of the present disclosure.

Although the present disclosure has been described as the configuration of hardware in the aforementioned example embodiments, the present disclosure is not limited thereto. The present disclosure can also be achieved by causing a central processing unit (CPU) to execute a computer program for part or all of the control processing in the seabed optical communication system SYS1.

The above-described program includes a command group (or software codes) for causing a computer to perform one or more functions that have been described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of transmission signals.

Some or all of the above example embodiments may be described as the following Supplementary Notes, but are not limited to the following.

### Supplementary Note 1

A seabed optical communication system including:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber,
in which at least one of the plurality of terminal devices includes:
a monitoring circuit that monitors a signal transmission status of the first multicore fiber; and
a control circuit that switches a transmission path of an optical signal transmitted by a first partial core determined to be faulty to another first partial core that transmits an optical signal having a lower priority than that of the first partial core determined to be faulty in a case where the monitoring circuit determines that any of a plurality of first partial cores configuring a first partial multicore fiber provided between the first seabed device and the second seabed device among the first multicore fibers is faulty.

### Supplementary Note 2

The seabed optical communication system according to Supplementary Note 1, in which at least one of the plurality of terminal devices further includes a priority setting circuit that sets a priority of an optical signal to be transmitted to each of a plurality of first cores configuring the first multicore fiber.

### Supplementary Note 3

The seabed optical communication system according to Supplementary Note 2, in which the priority setting circuit sets different priorities depending on a time slot for each of a plurality of first cores configuring the first multicore fiber.

### Supplementary Note 4

The seabed optical communication system according to Supplementary Note 2, in which the priority setting circuit sets a common priority to first cores belonging to a first group among a plurality of first cores configuring the first multicore fiber, and sets a common priority to first cores belonging to a second group.

### Supplementary Note 5

The seabed optical communication system according to Supplementary Note 2, in which the priority setting circuit sets a highest priority to at least one of first cores belonging to a first group and at least one of first cores belonging to a second group among a plurality of first cores configuring the first multicore fiber.

### Supplementary Note 6

The seabed optical communication system according to Supplementary Note 2, in which the priority setting circuit sets a priority to each of first cores belonging to a first group and first cores belonging to a second group among a plurality of first cores configuring the first multicore fiber in such a way that a ratio between the number of first cores belonging to the first group and the number of first cores belonging to the second group is maintained.

### Supplementary Note 7

The seabed optical communication system according to Supplementary Note 1, further including a third seabed device provided at a relay point of the first multicore fiber and configured to be able to switch connection of a plurality of first cores configuring the first multicore fiber,
in which in a case where the monitoring circuit determines that any of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to another second partial core that transmits an optical signal having a lower priority than that of the second partial core determined to be faulty.

### Supplementary Note 8

The seabed optical communication system according to Supplementary Note 7, in which at least one of the plurality of terminal devices further includes a priority setting circuit that sets a priority of an optical signal to be transmitted to each of a plurality of first cores configuring the first multicore fiber, and the priority setting circuit sets a priority to each of a plurality of first partial cores configuring a first partial multicore fiber provided between the first seabed device and the second seabed device in the first multicore fiber, and sets a priority to each of a plurality of second partial cores configuring a second partial multicore fiber provided between the second seabed device and the third seabed device in the first multicore fiber.

### Supplementary Note 9

The seabed optical communication system according to Supplementary Note 1, further including a second multicore fiber including a plurality of second cores, which transmits an optical signal used for communication between the plurality of terminal devices, in which
the first seabed device and the second seabed device are further configured to be switchable between connections of a plurality of second cores configuring the second multicore fiber,
in at least one of the plurality of terminal devices,
the monitoring circuit further monitors a signal transmission status of the second multicore fiber, and
in a case where the monitoring circuit determines that any of a plurality of third partial cores configuring the third partial multicore fiber provided between the first seabed device and the second seabed device in the second multicore fiber is faulty, the control circuit switches the transmission path of the optical signal transmitted by the third partial core determined to be faulty to another third partial core that transmits an optical signal having a lower priority than that of the third partial core determined to be faulty.

### Supplementary Note 10

The seabed optical communication system according to Supplementary Note 9, in which at least one of the plurality of terminal devices further includes a priority setting circuit that sets a priority of an optical signal to be transmitted to each of a plurality of first cores configuring the first multicore fiber and each of a plurality of second cores configuring the second multicore fiber.

### Supplementary Note 11

The seabed optical communication system according to Supplementary Note 10, in which the priority setting circuit sets different priorities depending on a time slot to each of a plurality of first cores configuring the first multicore fiber and each of a plurality of second cores configuring the second multicore fiber.

### Supplementary Note 12

The seabed optical communication system according to Supplementary Note 10, in which the priority setting circuit sets a common priority to first cores belonging to a first group and sets a common priority to first cores belonging to a second group among a plurality of first cores configuring the first multicore fiber, and sets a common priority to second cores belonging to a third group and sets a common priority to second cores belonging to a fourth group among a plurality of second cores configuring the second multicore fiber.

### Supplementary Note 13

The seabed optical communication system according to Supplementary Note 10, in which the priority setting circuit sets a highest priority to at least one of first cores belonging to a first group and at least one of first cores belonging to a second group among a plurality of first cores configuring the first multicore fiber, and sets a highest priority to at least one of second cores belonging to a third group and at least one of second cores belonging to a fourth group among a plurality of second cores configuring the second multicore fiber.

### Supplementary Note 14

The seabed optical communication system according to Supplementary Note 10, in which the priority setting circuit sets a priority to each of first cores belonging to a first group and first cores belonging to a second group among a plurality of first cores configuring the first multicore fiber in such a way that a ratio between the number of first cores belonging to the first group and the number of first cores belonging to the second group is maintained, and sets a priority to each of second cores belonging to a third group and second cores belonging to a fourth group among a plurality of second cores configuring the second multicore fiber in such a way that a ratio between the number of second cores belonging to the third group and the number of second cores belonging to the fourth group is maintained.

### Supplementary Note 15

The seabed optical communication system according to Supplementary Note 9, in which
in at least one of the plurality of terminal devices,
in a case where the monitoring circuit determines that any one of a plurality of first partial cores configuring a first partial multicore fiber provided between the first seabed device and the second seabed device in the first multicore fiber is faulty, the control circuit switches a transmission path of an optical signal transmitted by the first partial core determined to be faulty to any one of another first partial core that transmits an optical signal having a lower priority than that of the first partial core determined to be faulty, and a plurality of third partial cores configuring the third partial multicore fiber, and
in a case where the monitoring circuit determines that any one of a plurality of third partial cores configuring a third partial multicore fiber provided between the first seabed device and the second seabed device in the second multicore fiber is faulty, the control circuit switches a transmission path of an optical signal transmitted by the third partial core determined to be faulty to another third partial core that transmits an optical signal having a lower priority than that of the third partial core determined to be faulty or any one of a plurality of first partial cores configuring the first partial multicore fiber.

### Supplementary Note 16

The seabed optical communication system according to Supplementary Note 9, further including a third seabed device provided at relay points of the first and second multicore fibers and configured to be switchable between connection of a plurality of first cores configuring the first multicore fiber and connection of a plurality of second cores configuring the second multicore fiber, wherein
in a case where the monitoring circuit determines that any of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to another second partial core that transmits an optical signal having a lower priority than that of the second partial core determined to be faulty, and
in a case where the monitoring circuit determines that any one of a plurality of fourth partial cores configuring a fourth partial multicore fiber provided between the second seabed device and the third seabed device in the second multicore fiber is faulty, the control circuit switches a transmission path of the optical signal transmitted by the fourth partial core determined to be faulty to another fourth partial core that transmits an optical signal having a lower priority than that of the fourth partial core determined to be faulty.

### Supplementary Note 17

The seabed optical communication system according to Supplementary Note 16, in which
in at least one of the plurality of terminal devices,
in a case where the monitoring circuit determines that any one of a plurality of first partial cores configuring a first partial multicore fiber provided between the first seabed device and the second seabed device in the first multicore fiber is faulty, the control circuit switches a transmission path of an optical signal transmitted by the first partial core determined to be faulty to any one of another first partial core that transmits an optical signal having a lower priority than that of the first partial core determined to be faulty or a plurality of third partial cores configuring the third partial multicore fiber, and
in a case where the monitoring circuit determines that any one of a plurality of third partial cores configuring a third partial multicore fiber provided between the first seabed device and the second seabed device in the second multicore fiber is faulty, the control circuit switches a transmission path of an optical signal transmitted by the third partial core determined to be faulty to any one of another third partial core that transmits an optical signal having a lower priority than that of the third partial core determined to be faulty or a plurality of first partial cores configuring the first partial multicore fiber,
in a case where the monitoring circuit determines that any one of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to any one of another second partial core that transmits an optical signal having a lower priority than that of the second partial core determined to be faulty or a plurality of fourth partial cores configuring the fourth partial multicore fiber, and
in a case where the monitoring circuit determines that any one of a plurality of fourth partial cores configuring a fourth partial multicore fiber provided between the second seabed device and the third seabed device in the second multicore fiber is faulty, the control circuit switches a transmission path of an optical signal transmitted by the fourth partial core determined to be faulty to any one of another fourth partial core transmitting an optical signal having a lower priority than that of the fourth partial core determined to be faulty or a plurality of second partial cores configuring the second partial multicore fiber.

### Supplementary Note 18

A method of controlling a seabed optical communication system including:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber, the method including:
monitoring a signal transmission status of the first multicore fiber using at least one of the plurality of terminal devices; and
switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.

### Supplementary Note 19

A non-transitory computer-readable medium storing a control program for causing a computer to execute control processing in a seabed optical communication system including:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber, for causing the computer to execute:
monitoring a signal transmission status of the first multicore fiber using at least one of the plurality of terminal devices; and
switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.

### Supplementary Note 20

A seabed optical communication system, including:
a plurality of terminal devices;
a first multicore fiber including a plurality of first cores, which transmits an optical signal used for communication between the plurality of terminal devices;
a second multicore fiber including a plurality of second cores, which transmits an optical signal used for communication between the plurality of terminal devices;
a third multicore fiber including a plurality of third cores, which transmits an optical signal used for communication between the plurality of terminal devices; and
a first seabed device and a second seabed device provided at relay points of the first to third multicore fibers and configured to be able to switch connections of the first to third multicore fibers, in which
at least one of the plurality of terminal devices includes:
a monitoring circuit that monitors a signal transmission status of first to third partial multicore fibers provided between the first seabed device and the second seabed device among the first to third multicore fibers; and
a control circuit,
in a case where the monitoring circuit determines that any of the plurality of first partial cores configuring the first partial multicore fiber is faulty, the control circuit switches a transmission path of an optical signal transmitted by the first partial multicore fiber to the second partial multicore fiber or the third partial multicore fiber that transmits an optical signal having a lower priority than that of the first partial multicore fiber,
in a case where the monitoring circuit determines that any of the plurality of second partial cores configuring the second partial multicore fiber is faulty, the control circuit switches a transmission path of an optical signal transmitted by the second partial multicore fiber to the first partial multicore fiber or the third partial multicore fiber that transmits an optical signal having a lower priority than that of the second partial multicore fiber, and
in a case where the monitoring circuit determines that any one of the plurality of third partial cores configuring the third partial multicore fiber is faulty, the control circuit switches the transmission path of the optical signal transmitted by the third partial multicore fiber to the first partial multicore fiber or the second partial multicore fiber that transmits the optical signal having a lower priority than that of the third partial multicore fiber.

While the present disclosure has been particularly shown and described with reference to example embodiments thereof, the present disclosure is not limited to the above. It will be understood by those of ordinary skill in the art that various changes in form and details may be made therein without departing from the spirit and scope of the present disclosure as defined by the claims.

### REFERENCE SIGNS LIST

SYS1 seabed optical communication system
SYS2 seabed optical communication system
SYS3 seabed optical communication system
1, 1_1 to 1_5 terminal device
2, 2_1 to 2_3 seabed device
3 seabed cable
4 seabed cable
101 monitoring circuit
102 control circuit
103 priority setting circuit

1. A seabed optical communication system comprising:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber,
wherein at least one of the plurality of terminal devices comprises:
a monitoring circuit that monitors a signal transmission status of the first multicore fiber; and
a control circuit that switches a transmission path of an optical signal transmitted by a first partial core determined to be faulty to another first partial core that transmits an optical signal having a lower priority than that of the first partial core determined to be faulty in a case where the monitoring circuit determines that any of a plurality of first partial cores configuring a first partial multicore fiber provided between the first seabed device and the second seabed device among the first multicore fibers is faulty.

2. The seabed optical communication system according to claim 1, wherein at least one of the plurality of terminal devices further comprises a priority setting circuit that sets a priority of an optical signal to be transmitted to each of a plurality of first cores configuring the first multicore fiber.

3. The seabed optical communication system according to claim 2, wherein the priority setting circuit sets different priorities depending on a time slot for each of a plurality of first cores configuring the first multicore fiber.

4. The seabed optical communication system according to claim 2, wherein the priority setting circuit sets a common priority to first cores belonging to a first group among a plurality of first cores configuring the first multicore fiber, and sets a common priority to first cores belonging to a second group.

5. The seabed optical communication system according to claim 2, wherein the priority setting circuit sets a highest priority to at least one of first cores belonging to a first group and at least one of first cores belonging to a second group among a plurality of first cores configuring the first multicore fiber.

6. The seabed optical communication system according to claim 2, wherein the priority setting circuit sets a priority to each of first cores belonging to a first group and first cores belonging to a second group among a plurality of first cores configuring the first multicore fiber in such a way that a ratio between the number of first cores belonging to the first group and the number of first cores belonging to the second group is maintained.

7. The seabed optical communication system according to claim 1, further comprising a third seabed device provided at a relay point of the first multicore fiber and configured to be able to switch connection of a plurality of first cores configuring the first multicore fiber,
wherein in a case where the monitoring circuit determines that any of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to another second partial core that transmits an optical signal having a lower priority than that of the second partial core determined to be faulty.

8. The seabed optical communication system according to claim 7, wherein at least one of the plurality of terminal devices further comprises a priority setting circuit that sets a priority of an optical signal to be transmitted to each of a plurality of first cores configuring the first multicore fiber, and
the priority setting circuit sets a priority to each of a plurality of first partial cores configuring a first partial multicore fiber provided between the first seabed device and the second seabed device in the first multicore fiber, and sets a priority to each of a plurality of second partial cores configuring a second partial multicore fiber provided between the second seabed device and the third seabed device in the first multicore fiber.

9. The seabed optical communication system according to claim 1, further comprising a second multicore fiber including a plurality of second cores, which transmits an optical signal used for communication between the plurality of terminal devices, wherein
the first seabed device and the second seabed device are further configured to be switchable between connections of a plurality of second cores configuring the second multicore fiber,
in at least one of the plurality of terminal devices,
the monitoring circuit further monitors a signal transmission status of the second multicore fiber, and
in a case where the monitoring circuit determines that any of a plurality of third partial cores configuring the third partial multicore fiber provided between the first seabed device and the second seabed device in the second multicore fiber is faulty, the control circuit switches the transmission path of the optical signal transmitted by the third partial core determined to be faulty to another third partial core that transmits an optical signal having a lower priority than that of the third partial core determined to be faulty.

10. The seabed optical communication system according to claim 9, wherein at least one of the plurality of terminal devices further comprises a priority setting circuit that sets a priority of an optical signal to be transmitted to each of a plurality of first cores configuring the first multicore fiber and each of a plurality of second cores configuring the second multicore fiber.

11. The seabed optical communication system according to claim 10, wherein the priority setting circuit sets different priorities depending on a time slot to each of a plurality of first cores configuring the first multicore fiber and each of a plurality of second cores configuring the second multicore fiber.

12. The seabed optical communication system according to claim 10, wherein the priority setting circuit sets a common priority to first cores belonging to a first group and sets a common priority to first cores belonging to a second group among a plurality of first cores configuring the first multicore fiber, and sets a common priority to second cores belonging to a third group and sets a common priority to second cores belonging to a fourth group among a plurality of second cores configuring the second multicore fiber.

13. The seabed optical communication system according to claim 10, wherein the priority setting circuit sets a highest priority to at least one of first cores belonging to a first group and at least one of first cores belonging to a second group among a plurality of first cores configuring the first multicore fiber, and sets a highest priority to at least one of second cores belonging to a third group and at least one of second cores belonging to a fourth group among a plurality of second cores configuring the second multicore fiber.

14. The seabed optical communication system according to claim 10, wherein the priority setting circuit sets a priority to each of first cores belonging to a first group and first cores belonging to a second group among a plurality of first cores configuring the first multicore fiber in such a way that a ratio between the number of first cores belonging to the first group and the number of first cores belonging to the second group is maintained, and sets a priority to each of second cores belonging to a third group and second cores belonging to a fourth group among a plurality of second cores configuring the second multicore fiber in such a way that a ratio between the number of second cores belonging to the third group and the number of second cores belonging to the fourth group is maintained.

15. The seabed optical communication system according to claim 9, wherein
in at least one of the plurality of terminal devices,
in a case where the monitoring circuit determines that any one of a plurality of first partial cores configuring a first partial multicore fiber provided between the first seabed device and the second seabed device in the first multicore fiber is faulty, the control circuit switches a transmission path of an optical signal transmitted by the first partial core determined to be faulty to any one of another first partial core that transmits an optical signal having a lower priority than that of the first partial core determined to be faulty, and a plurality of third partial cores configuring the third partial multicore fiber, and
in a case where the monitoring circuit determines that any one of a plurality of third partial cores configuring a third partial multicore fiber provided between the first seabed device and the second seabed device in the second multicore fiber is faulty, the control circuit switches a transmission path of an optical signal transmitted by the third partial core determined to be faulty to any one of another third partial core that transmits an optical signal having a lower priority than that of the third partial core determined to be faulty or a plurality of first partial cores configuring the first partial multicore fiber.

16. The seabed optical communication system according to claim 9, further comprising a third seabed device provided at relay points of the first and second multicore fibers and configured to be switchable between connection of a plurality of first cores configuring the first multicore fiber and connection of a plurality of second cores configuring the second multicore fiber, wherein
in a case where the monitoring circuit determines that any of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to another second partial core that transmits an optical signal having a lower priority than that of the second partial core determined to be faulty, and
in a case where the monitoring circuit determines that any one of a plurality of fourth partial cores configuring a fourth partial multicore fiber provided between the second seabed device and the third seabed device in the second multicore fiber is faulty, the control circuit switches a transmission path of the optical signal transmitted by the fourth partial core determined to be faulty to another fourth partial core that transmits an optical signal having a lower priority than that of the fourth partial core determined to be faulty.

17. The seabed optical communication system according to claim 16, wherein
in at least one of the plurality of terminal devices,
in a case where the monitoring circuit determines that any one of a plurality of first partial cores configuring a first partial multicore fiber provided between the first seabed device and the second seabed device in the first multicore fiber is faulty, the control circuit switches a transmission path of an optical signal transmitted by the first partial core determined to be faulty to any one of another first partial core that transmits an optical signal having a lower priority than that of the first partial core determined to be faulty or a plurality of third partial cores configuring the third partial multicore fiber, and
in a case where the monitoring circuit determines that any one of a plurality of third partial cores configuring a third partial multicore fiber provided between the first seabed device and the second seabed device in the second multicore fiber is faulty, the control circuit switches a transmission path of an optical signal transmitted by the third partial core determined to be faulty to any one of another third partial core that transmits an optical signal having a lower priority than that of the third partial core determined to be faulty or a plurality of first partial cores configuring the first partial multicore fiber,
in a case where the monitoring circuit determines that any one of a plurality of second partial cores configuring a second partial multicore fiber provided between the second seabed device and the third seabed device in the first multicore fiber is faulty, the control circuit switches a transmission path of an optical signal transmitted by the second partial core determined to be faulty to any one of another second partial core that transmits an optical signal having a lower priority than that of the second partial core determined to be faulty or a plurality of fourth partial cores configuring the fourth partial multicore fiber, and
in a case where the monitoring circuit determines that any one of a plurality of fourth partial cores configuring a fourth partial multicore fiber provided between the second seabed device and the third seabed device in the second multicore fiber is faulty, the control circuit switches a transmission path of an optical signal transmitted by the fourth partial core determined to be faulty to any one of another fourth partial core transmitting an optical signal having a lower priority than that of the fourth partial core determined to be faulty or a plurality of second partial cores configuring the second partial multicore fiber.

18. A method of controlling a seabed optical communication system including:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber, the method comprising:
monitoring a signal transmission status of the first multicore fiber using at least one of the plurality of terminal devices; and
switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.

19. A non-transitory computer-readable medium storing a control program for causing a computer to execute control processing in a seabed optical communication system including:
a plurality of terminal devices;
a first multicore fiber including a plurality of first cores, which transmits an optical signal used for communication between the plurality of terminal devices; and
a first seabed device and a second seabed device provided at relay points of the first multicore fiber and configured to be able to switch connection of a plurality of first cores configuring the first multicore fiber,
for causing the computer to execute:
monitoring a signal transmission status of the first multicore fiber using at least one of the plurality of terminal devices; and
switching a transmission path of an optical signal transmitted by a first partial core determined to be faulty to another first partial core that transmits an optical signal having a lower priority than that of the first partial core determined to be faulty in a case where it is determined that any of a plurality of first partial cores configuring a first partial multicore fiber provided between the first seabed device and the second seabed device among the first multicore fibers is faulty.
